(19) United States
(12) Patent Application Publication
(10) Pub. No.: US 2024/0276445 A1
(43) Pub. Date: Aug. 15, 2024

(54) MEASUREMENT REPORTING BASED ON WAYPOINT

(71) Applicant: InterDigital Patent Holdings, Inc., Wilmington, DE (US)

(72) Inventors: Martino Freda, Laval (CA); Oumer Teyeb, Montreal (CA); Paul Marinier, Brossard (CA); Dylan Watts, Montreal (CA); Brian Martin, Farnham (GB); Keiichi Kubota, Setagaya-Ku (JP)

(73) Assignee: InterDigital Patent Holdings, Inc., Wilmington, DE (US)

(21) Appl. No.: 18/440,631

(22) Filed: Feb. 13, 2024

Related U.S. Application Data
(60) Provisional application No. 63/445,586, filed on Feb. 14, 2023.

(51) Int. Cl. H04W 64/00; H04B 7/06; H04W 24/10

(52) U.S. Cl. CPC H04W 64/006; H04B 7/0617; H04W 24/10

(57) ABSTRACT

A wireless transmit/receive unit (WTRU) may be configured to receive configuration information from a network indicating first reporting behavior and second reporting behavior to be applied when reporting measurements associated with a beam. The configuration information may indicate a condition associated with a height of the WTRU, a speed of the WTRU, and/or a location of the WTRU. The WTRU may be configured to determine whether the condition associated with the height of the WTRU, the speed of the WTRU, and/or the location of the WTRU has been satisfied. The WTRU may be configured to send a report indicating the beam measurements of the candidate set of cells using the first reporting behavior or the second reporting behavior based on whether the condition associated with the height of the WTRU, the speed of the WTRU, and/or the location of the WTRU has been satisfied.

### CROSS-REFERENCE TO RELATED APPLICATIONS

This application claims the benefit of U.S. Provisional Application No. 63/445,586 filed on Feb. 14, 2023, the entire contents of which are incorporated herein by reference.

### BACKGROUND

In an RRC_CONNECTED mode, a wireless transmit/receive unit (WTRU) may measure and/or detect multiple beams (e.g., at least one) of a cell and the measurements results (e.g., power values) may be averaged to derive the cell quality. In doing so, the WTRU may be configured to consider a subset of the measured/detected beams. In examples, filtering may take place at two different levels: at the physical layer to derive beam quality and then at RRC level to derive cell quality from multiple beams. In examples, cell quality from beam measurements may be derived in the same way for the serving cell(s) and for the non-serving cell(s). In examples, measurement reports may include the measurement results of the X best beams if the WTRU is configured to do so by the gNB.

### SUMMARY

A wireless transmit/receive unit (WTRU) may be configured to receive configuration information from a network indicating first reporting behavior and second reporting behavior to be applied when reporting measurements associated with a beam. The configuration information may indicate a condition associated with a height of the WTRU, a speed of the WTRU, and/or a location of the WTRU. The WTRU may be configured to determine whether the condition associated with the height of the WTRU, the speed of the WTRU, and/or the location of the WTRU has been satisfied. The WTRU may be configured to send a report indicating the beam measurements of the candidate set of cells using the first reporting behavior or the second reporting behavior based on whether the condition associated with the height of the WTRU, the speed of the WTRU, and/or the location of the WTRU has been satisfied.

The beam measurements of the candidate set of cells may be reported using the first reporting behavior when the condition associated with one or more of the height of the WTRU, the speed of the WTRU, or the location of the WTRU has not been satisfied. The beam measurements of the candidate set of cells may be reported using the second reporting behavior when the condition associated with the height of the WTRU, the speed of the WTRU, and/or the location of the WTRU has been satisfied. The first reporting behavior may include a first reporting periodicity and/or a first number of beams included in the report. The second reporting behavior may include a second reporting periodicity and/or a second number of beams included in the report.

The WTRU may be configured to determine a reporting interval to send the measurements based on the condition. The reporting interval may be associated with event-based reporting or periodic reporting. The location of the WTRU may include a relative location associated with a waypoint. The height of the WTRU may include a relative height of the WTRU. The speed of the WTRU may include a relative speed of the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example high-level measurement model.

FIG. 3 is a diagram illustrating an example of layer 1/layer 2 triggered mobility (LTM) operation using carrier aggregation (CA).

FIG. 4 is a diagram illustrating an example LTM baseline procedure.

FIG. 5 is a diagram illustrating an example signaling flow for a flight path report.

### DETAILED DESCRIPTION

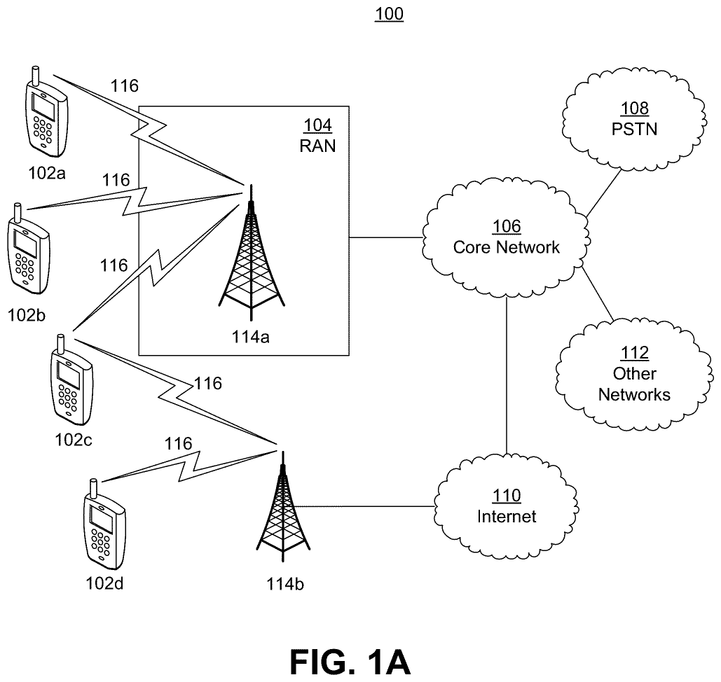

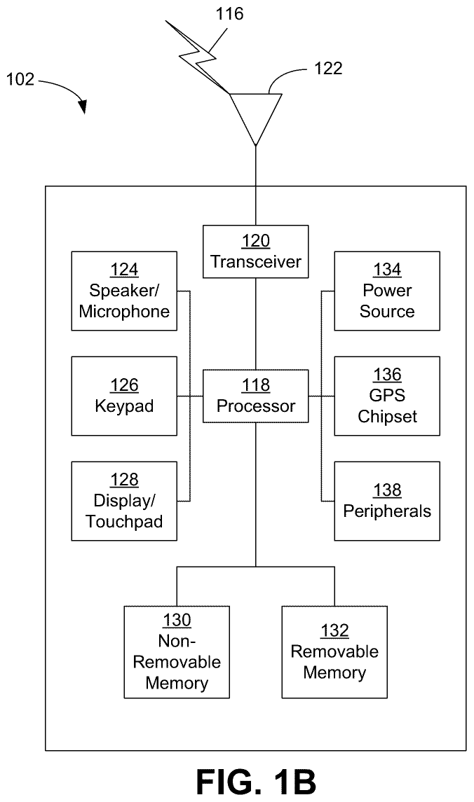

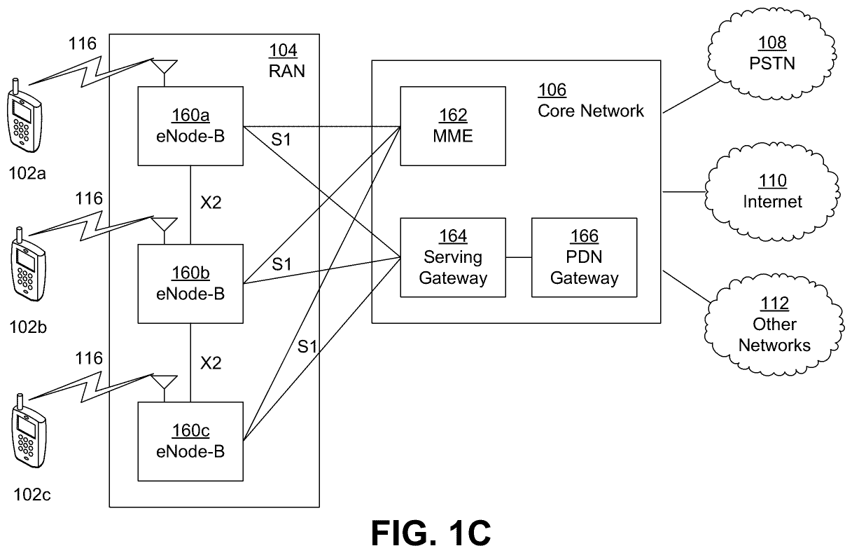

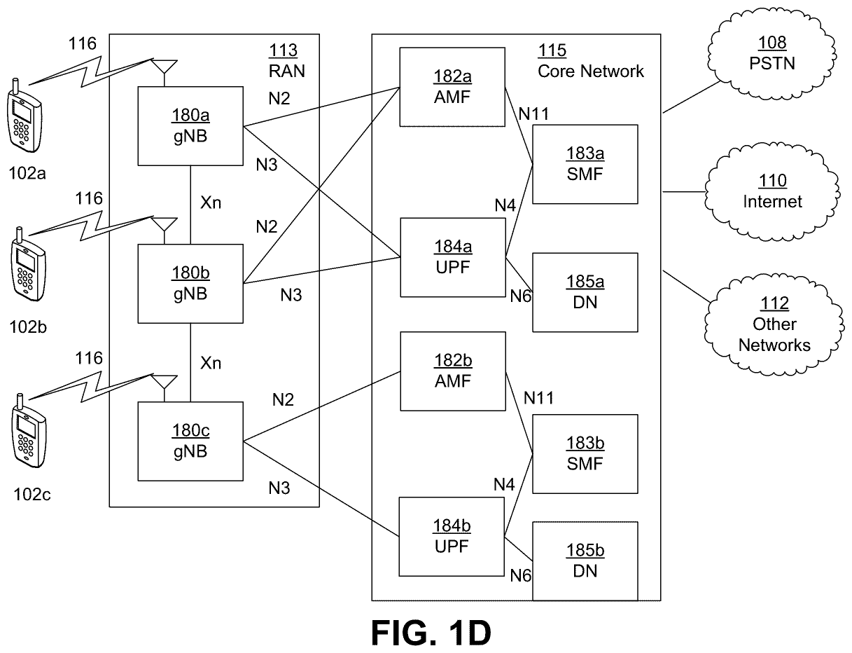

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In examples, in RRC_CONNECTED, a WTRU may measure and/or detect multiple beams (e.g., at least one) of a cell and the measurements results (e.g., power values) may be averaged to derive the cell quality. In doing so, the WTRU may be configured to consider a subset of the measured/detected beams. In examples, filtering may take place at two different levels: at the physical layer to derive beam quality and then at RRC level to derive cell quality from multiple beams. In examples, cell quality from beam measurements may be derived in the same way for the serving cell(s) and for the non-serving cell(s). In examples, measurement reports may include the measurement results of the X best beams if the WTRU is configured to do so by the gNB.

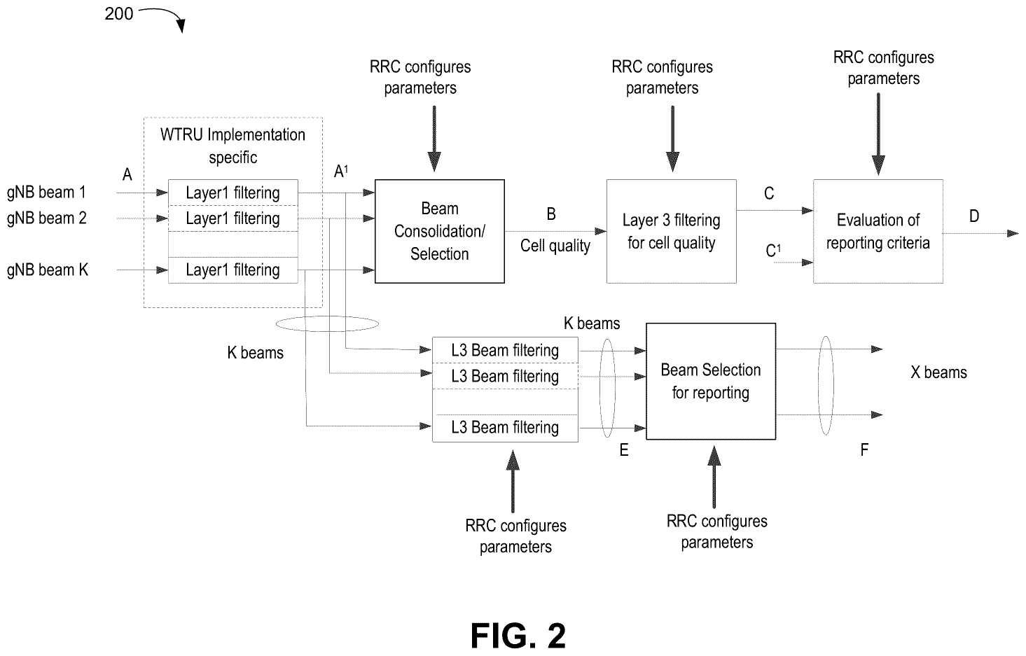

FIG. 2 shows an example illustration of a corresponding high-level measurement model 200. In examples, K beams may correspond to the measurements on SSB and/or CSI-RS resources configured for L3 mobility by gNB and detected by WTRU at L1. In FIG. 2, A shows measurements (e.g., beam specific samples) internal to the physical layer. Layer 1 filtering illustrates internal layer 1 filtering of the inputs measured at point A. Exact filtering may be implementation dependent (e.g., WTRU implementation specific). In examples, how the measurements are executed in the physical layer by an implementation (e.g., inputs A and Layer 1 filtering) may not be constrained by the standard. In FIG. 2, A1 shows measurements (e.g., beam specific measurements) that may be reported by layer 1 to layer 3 after layer 1 filtering. In FIG. 2, Beam Consolidation/Selection may occur where beam specific measurements are consolidated to derive cell quality. In examples, the behavior of the Beam consolidation/selection may be standardized and the configuration of this module may be provided by RRC signaling. In examples, the reporting period at B may be equal to one measurement period at A1. At B, a measurement (e.g., cell quality) may be derived from beam-specific measurements that may be reported to layer 3 after beam consolidation/selection.

In examples, Layer 3 filtering for cell quality may be carried out by filtering performed on the measurements provided at point B. In examples, the behavior of the Layer 3 filters may be standardized and the configuration of the layer 3 filters may be provided by RRC signaling. In examples, the filtering reporting period at C may be equal to one measurement period at B. In FIG. 2, C illustrates a measurement after processing in the layer 3 filter. The reporting rate may be identical to the reporting rate at point B. This measurement may be used as input for one or more evaluation or reporting criteria. In examples, evaluation of reporting criteria may be carried out by checks of whether actual measurement reporting is necessary at point D. In examples, the evaluation of reporting criteria may be based on more than one flow of measurements at reference point C (e.g. to compare between different measurements). In examples, the flow of measurements may refer to having measurements associated with different cells (e.g., to which averaging may be performed in parallel) being available at point C. For example, FIG. 2 may be applied to each cell measurement or flow of measurements. The evaluation(s) of reporting criteria may be represented as inputs at C and/or C1. In examples, the WTRU may evaluate the reporting criteria at least every time a new measurement result is reported at point C and/or C1. The reporting criteria may be standardized and/or the configuration may be provided by RRC signaling (e.g., WTRU measurements).

In FIG. 2 at D, measurement report information (e.g., message) may be sent on the radio interface. L3 Beam filtering may occur as filtering that may be performed on the measurements (e.g., beam specific measurements) that may be provided at point A1. In examples, the behavior of the beam filters may be standardized and the configuration of the beam filters may be provided by RRC signaling. In examples, the filtering reporting period at E, shown in FIG. 2, may be equal to one measurement period at A1. In examples, E may represent a measurement (e.g., beam-specific measurement) after processing in the beam filter. In examples, the reporting rate may be identical to the reporting rate at point A1. This measurement may be used as input for selecting the X measurements to be reported. In FIG. 2, Beam Selection for beam reporting includes selecting the X measurements from the measurements provided at point E. In examples, the behavior of the beam selection may be standardized and the configuration of this module may be provided by RRC signaling. In FIG. 2, F illustrates when beam measurement information may be included in measurement report (e.g., sent) on the radio interface. In examples, Layer 1 filtering may introduce a certain level of measurement averaging. In examples, how and when the WTRU may perform the required measurements may be implementation-specific to the point that the output at B may fulfill one or more performance requirements. In examples, Layer 3 filtering for cell quality and/or related parameters used may not introduce any delay in the sample availability between B and C. In examples, C¹ may be the input used in the event evaluation. In examples, L3 Beam filtering and/or related parameters used may not introduce any delay in the sample availability between E and F.

In examples, measurement reports may be characterized by one or more of the following. For example, measurement reports may include the measurement identity of the associated measurement configuration that triggered the reporting. For example, cell and/or beam measurement quantities to be included in measurement reports may be configured by the network. For example, the number of non-serving cells to be reported may be limited through configuration by the network. For example, cells belonging to an exclude-list configured by the network may not be used in event evaluation and reporting. For example, when an allow-list is configured by the network, one or more (e.g., only the) cells belonging to the allow-list may be used in event evaluation and reporting. For example, beam measurements to be included in measurement reports may be configured by the network (e.g., beam identifier only, measurement result and beam identifier, or no beam reporting).

In examples, intra-frequency neighbor (cell) measurements and inter-frequency neighbor (cell) measurements may be defined as follows. For example, for SSB based intra-frequency measurements, a measurement may be defined as an SSB based intra-frequency measurement provided the center frequency of the SSB of the serving cell and the center frequency of the SSB of the neighbor cell are the same, and the subcarrier spacing of the two SSBs is also the same. For example, for SSB based inter-frequency measurement, a measurement may be defined as an SSB based inter-frequency measurement provided the center frequency of the SSB of the serving cell and the center frequency of the SSB of the neighbor cell are different, or the subcarrier spacing of the two SSBs is different. For SSB based measurements, one measurement object may correspond to one SSB and the WTRU may consider different SSBs as different cells.

For CSI-RS based intra-frequency measurement, a measurement may be defined as a CSI-RS based intra-frequency measurement provided that, one or more, of all, of the following are true. The subcarrier spacing of CSI-RS resources on the neighbor cell configured for measurement may be the same as the SCS of CSI-RS resources on the serving cell indicated for measurement. For 60 kHz subcarrier spacing, the CP type of CSI-RS resources on the neighbor cell configured for measurement may be the same as the CP type of CSI-RS resources on the serving cell indicated for measurement. The center frequency of CSI-RS resources on the neighbor cell configured for measurement may be the same as the center frequency of CSI-RS resource on the serving cell indicated for measurement.

For CSI-RS based inter-frequency measurement, a measurement may be defined as a CSI-RS based inter-frequency measurement if it is not a CSI-RS based intra-frequency measurement. In examples, extended CP for CSI-RS based measurement may be not supported.

In examples, whether a measurement is non-gap-assisted or gap-assisted may depend on the capability of the WTRU, the active BWP of the WTRU and the current operating frequency. For example, for SSB based inter-frequency measurement, if the measurement gap requirement information is reported by the WTRU, a measurement gap configuration may be provided according to the information. A measurement gap configuration may be provided in the following cases: if the WTRU supports (e.g., only supports) per-UE measurement gaps; if the WTRU supports per-FR measurement gaps and any of the serving cells are in the same frequency range of the measurement object. For example, for SSB based intra-frequency measurement, if the measurement gap requirement information is reported by the WTRU, a measurement gap configuration may be provided according to the information. For example, a measurement gap configuration may be provided in the following case: other than the initial BWP, if any of the WTRU configured BWPs do not include the frequency domain resources of the SSB associated to the initial DL BWP. In examples, in non-gap-assisted scenarios, the WTRU may be able to carry out such measurements without measurement gaps. In gap-assisted scenarios, the WTRU may not be assumed to be able to carry out such measurements without measurement gaps.

In examples, inter-cell beam management may be used, which may manage the beams in CA case, but it may that no cell change/add is supported. In examples, specify mechanism and procedures of L1/L2 based inter-cell mobility for mobility latency reduction may be specified in accordance with the following. For example, to specify mechanism and procedures of L1/L2 based inter-cell mobility for mobility latency reduction, the following may be performed: configuration and maintenance for multiple candidate cells to allow fast application of configurations for candidate cells; dynamic switch mechanism among candidate serving cells (including SpCell and SCell) for the potential applicable scenarios based on L1/L2 signalling; L1 enhancements for inter-cell beam management, including L1 measurement and reporting, and beam indication; Timing Advance management; and CU-DU interface signaling to support L1/L2 mobility, if needed. For example, early RAN2 involvement may be necessary, including the possibility of further clarifying the interaction between this bullet with the previous bullet.

For example, FR2 specific enhancements may not be precluded, if any. For example, the procedure of L1/L2 based inter-cell mobility may be applicable to the following scenarios: standalone, CA and NR-DC case with serving cell change within one CG Intra-DU case and intra-CU inter-DU case (e.g., applicable for Standalone and CA: no new RAN interfaces are expected); both intra-frequency and inter-frequency; both FR1 and FR2; source and target cells may be synchronized or non-synchronized; and inter-CU case is not included.

L1/L2 based mobility was originally started in R17 and inter-cell beam management in R17 addresses intra-DU and intra-frequency scenarios. In this case the serving cell may remain unchanged (e.g., there is no possibility to change the serving cell using L1/2 based mobility). In FR2 deployments, CA may typically be used in order to exploit the available bandwidth, e.g. to aggregate multiple CCs in one band. These CCs may typically be transmitted with the same analog beam pair (e.g., gNB beam and WTRU beam). The WTRU may be configured with TCI states (e.g., which may be a fairly large number, e.g. 64) for reception of PDCCH and PDSCH. Each TCI state may include a RS or SSB that the WTRU may refer to for setting its beam. In examples, the SSB may be associated with a non-serving PCI. MAC signaling may activate the TCI state for a Coreset/PDCCH. Reception of PDCCH from a non-serving cell may be supported by MAC CE indicating a TCI state associated to non-serving PCI. MAC signaling may activate a subset of (e.g., up to) 8 TCI states for PDSCH reception. DCI may indicate which of the 8 TCI states. A unified TCI state with a different updating mechanism (e.g., DCI-based) may be supported, but without multi-TRP. Unified TCI state with multi-TRP may also be supported.

LTM may improve handover latency. For example, with a conventional L3 handover or conditional handover, the WTRU may first send a measurement report using RRC signaling. In response to this, the network may provide a further measurement configuration and potentially a conditional handover configuration. With a conventional handover, the network may provide a configuration for a target cell after the WTRU reports using RRC signaling that the cell meets a configured radio quality criteria. With conditional handover, in order to reduce the handover failure rate due to the delay in sending a measurement report then receiving an RRC reconfiguration the network may provide, in advance, a target cell configuration as well as a measurement criteria which may determine when the WTRU should trigger the CHO configuration. In examples, both of these L3 methods, may experience a delay due to the sending of measurement reports and receiving of target configurations, for example, particularly in case of the conventional (non-conditional) handover.

In examples, the aim of LTM may be to allow a fast application of configurations for candidate cells, which may include dynamically switching between SCells and the switching of the PCell (e.g. switch the roles between SCell and PCell) without performing RRC signaling. The inter-CU case may not be included, as this may require relocation of the PDCP anchor and may have already been excluded from the work item. Therefore, an RRC based approach may be needed at least to support inter-CU handover.

With legacy L3 handover mechanisms, currently active SCell(s) may be released before the WTRU moves completes the handover to a target cell in the coverage area of a new site and may (e.g. only) be added back after successful handover, which may lead to throughput degradation during handover. L1/2 may enable CA operation to be enabled instantaneously upon serving cell change.

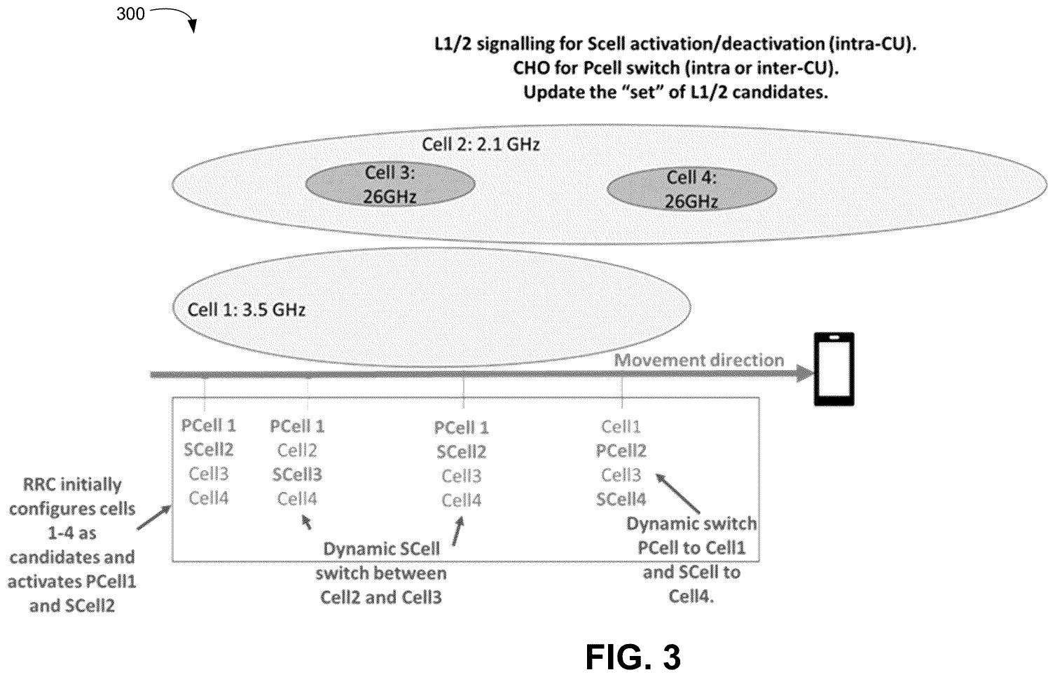

FIG. 3 shows an example LTM operation 300, whereby the candidate cell group may be configured by RRC and a dynamic switch of PCell and SCell may be achieved using L1/2 signalling.

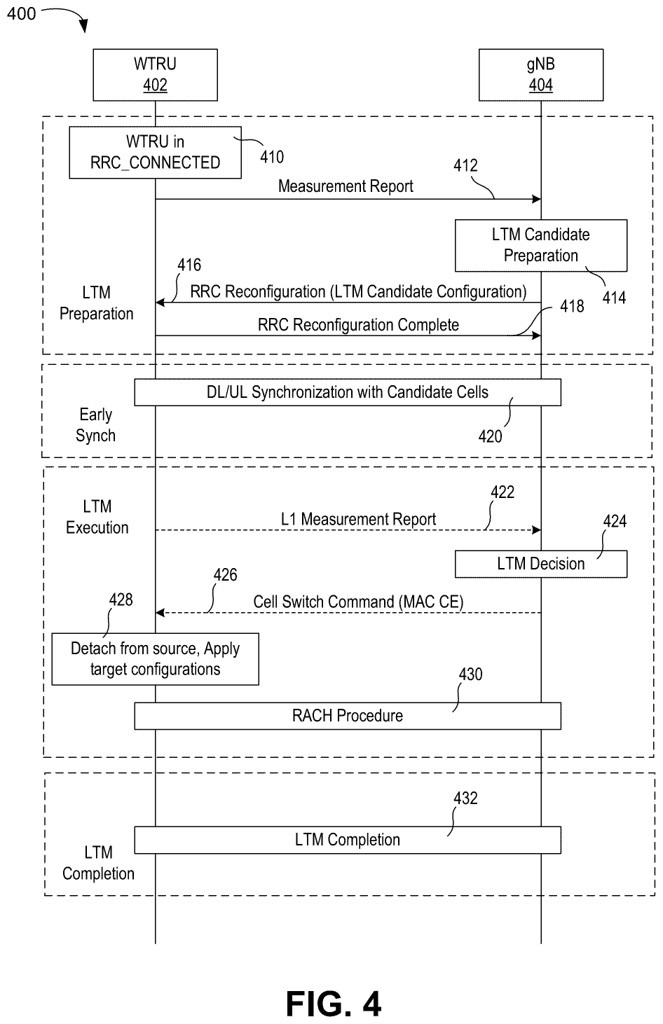

FIG. 4 illustrates an example baseline LTM procedure 400. As shown in FIG. 4, the LTM procedure 400 may be as follows. At 410, a WTRU 402 may initiate an RRC-Connected mode. At 412, the WTRU 402 may send a MeasurementReport message to a gNB 404. The gNB 404 may decide to use LTM and initiate LTM candidate preparation, at 414. At 416, the gNB 404 may transmit an RRCReconfiguration message to the WTRU 402. The RRCReconfiguration message may include the configuration of one or multiple LTM candidate target cells. At 418, the WTRU 402 may store the configuration of LTM candidate target cell(s) and transmit a RRCReconfigurationComplete message to the gNB 404. At 420, the WTRU 402 may perform DL synchronization and/or TA acquisition with candidate target cell(s), for example, before receiving the LTM cell switch command. In examples, DL synchronization for candidate cell(s) before cell switch command may be supported, at least based on SSB. In examples, TA acquisition of candidate cell(s) before LTM cell switch command may be supported, at least based on PDCCH ordered RACH, where the PDCCH order may be triggered (e.g., only triggered) by source cell. At 422, the WTRU 402 may perform one or more L1 measurements on the configured LTM candidate target cell(s) and may transmit one or more lower-layer measurement reports to the gNB 404. At 424, the gNB 404 may make an LTM decision, for example, based on the lower-layer measurement report(s). At 426, the gNB 404 may decide to execute LTM cell switch to a target cell and transmit a MAC CE triggering LTM cell switch by including the candidate configuration index of the target cell. The WTRU 402 may switch to the configuration of the LTM candidate target cell. At 430, the WTRU 402 may perform a random access procedure towards the target cell, for example, if TA is not available. At 432, the WTRU 402 may indicate successful completion of the LTM cell switch towards target cell.

Uncrewed aerial vehicles (UAV) (e.g., aerial WTRUs) travelling at a height of up to 300 m may be associated with one or more use cases including drone operation, personal entertainment for flight experience, and cargo delivery. As the basis of the applications, the capability for remote control and data transmissions may be key aspects for the following enhancements, specifically UL and DL interference and mobility. Aerial WTRUs may support height-triggered measurement reporting based on WTRU-capability. In examples, two height-based events may be defined. For example, in high-based event 1, aerial WTRU height may become higher than an absolute threshold. In high-based event 2, aerial WTRU height may become lower than an absolute threshold. In examples, height thresholds may be configured in MeasConfig via heightThreshRef, and support values ranging from −420 m to 8880 m in increments of 300 m. In examples, the WTRU may be configured in ReportConfigEUTRA with offsets h1-ThresholdOffset and h2-ThresholdOffset, and hysteresis parameters h1-Hysteresis and h2-Hysteresis to be respectively applied during event evaluation.

In examples, WTRU may be configured to include additional information (e.g. the WTRU height, location, and horizontal/vertical velocity) within a measurement report. For example, location reporting may be supported via the LocationInfo IE, which may be used to transfer detailed location information available at the WTRU to correlate measurements and WTRU position information. In examples, available information may include WTRU location information (e.g., via locationCoordinates) and WTRU bearing and horizontal speed (e.g., via horizontalVelocity)

In examples, reporting vertical information via verticalVelocityInfo. verticalVelocityInfo may include the choice between parameters verticalVelocity (which may, for example, include WTRU bearing, horizontal/vertical speed, and vertical direction), and verticalVelocityAndUncertainty (which may, for example, include information within verticalVelocity as well as uncertainty of horizontal and vertical speed).

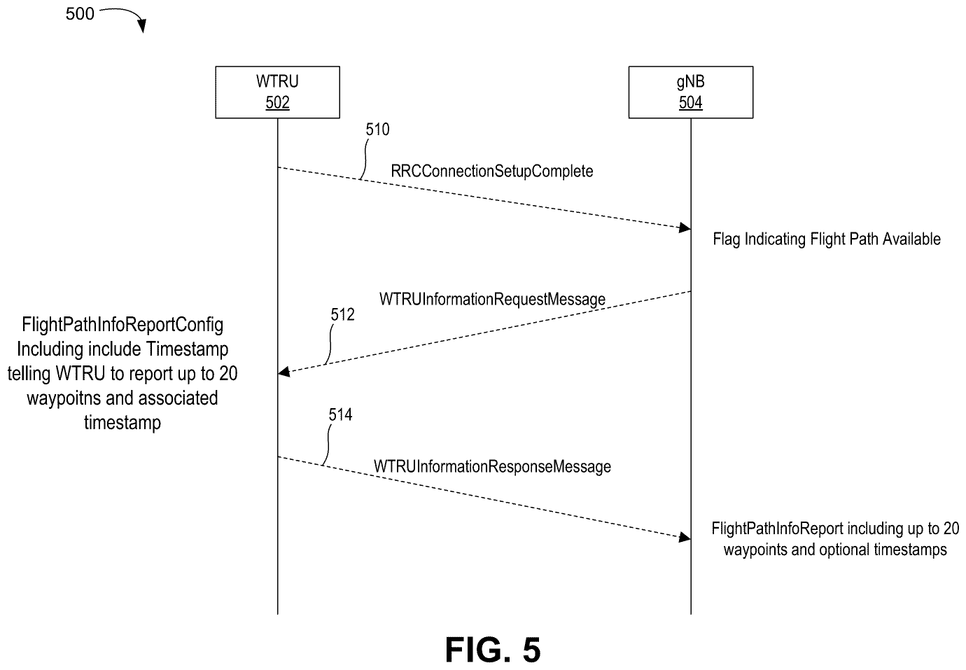

FIG. 5 shows an example illustration of a signaling flow 500 for a flight path report. In examples, flight path reporting may be supported for aerial WTRUs based on WTRU capability. Flight path information may include a number of waypoints, which may be 3D locations/coordinates. At 510, a WTRU 5002 may indicate if flight path information may be available via the RRCConnectionReconfigurationComplete, RRCConnectionReestablishmentComplete, RRCConnectionResumeComplete, or RRCConnectionSetupComplete messages. The fight path information may allow the network to determine after (e.g., immediately after) connection whether flight path information is available, which may enable subsequent flight path report configuration and request.

At 512, a gNB 504 may send a WTRU Information Request message to the WTRU 502. The E-UTRAN (e.g., gNB 504) may request the WTRU 502 to report flight path information via a flightPathInfoReq in the WTRUInformationRequest message. At 514, the WTRU 502 may send a WTRU Information Response message to the gNB 504. The WTRU 502 may include flightPathInfoReport in the WTRUInformationResponseMessage including one or more (e.g., all) available waypoints up to the configured maximum, based on the request to report WTRU flight path information. Such information may be useful to the network for, for example, collision avoidance, resource provisioning, and/or WTRU configuration. In examples, a configuration of up to 20 waypoint locations may be supported within a flight path report. The WTRU 502 may be configured to include time stamp information associated to each waypoint via includeTimeStamp within FlightPathInforReportConfig. Time stamps may improve predictability of the WTRU location at a given time, further aiding planning of WTRU configuration and future resource allocation. In examples, time stamp information may not always be known, and may (e.g., only) be included in a flight path report if such information is available at the WTRU 502.

In examples, an aerial WTRU may be configured with an RRM event (e.g. A3, A4, or A5) which may trigger measurement reporting when per-cell RSRP values for configured number of cells fulfill the configured event. Once a measurement report is sent, the list of triggered cells may be updated when subsequent cell(s) fulfill the event. In examples, additional measurement reports may be not sent while the list of triggered cells remains larger than the configured number of cells. In examples, the number of triggered cells required for measurement reporting may be provided in ReportConfigEUTRA via numberOfTriggeringCells and may range from 2 up to a maximum of 8. Such information may be useful, for example, for interference detection and/or to reduce signaling overhead by reducing the number of measurement reports.

In examples, additional considerations for UAV may include height dependent parameter scaling, user consent for location reporting, a flight path update after initial report, and/or consideration of beams and report on leave condition in numberoftriggeringcells. In examples, a UAV enhancement may include flight path reporting (e.g. location coordinates and timestamp) and/or NR updating of flight path information. A UAV enhancement may include mobility control, for example, height based parameter scaling, height based events based on WTRU location info, and/or H1 for above (e.g., greater than) a threshold, and H2 for below the threshold. A UAV enhancement may include an interference control (e.g. number of triggered cells (A3, A4, A5), triggered cells list in MR), which may include potential new events B1/B2 (inter-RAT) and/or beam impacts.

In examples, mobility control and interference control are part of UAV work. An issue at RAN level regarding the support of drones and UAVs may be interference and excessive measurement reporting. Due to the height of the drone, many cells may appear to have roughly the same strength, which may lead to constant satisfaction of measurement events and frequent measurement reporting. This problem may be magnified if L1/L2 triggered mobility is used for UAVs, considering that the WTRU may be expected to report L1/L2 measurements of cells/beams to enable the network to trigger LTM. In examples, this may result in LTM being triggered by the network, which may result in ping-ponging and delay caused by interruption (e.g., due to reset of the MAC or other protocol layers required when a cell is changed). As a result, enhancements to the eventual measurement procedures specific to LTM may be required to avoid interference and excessive signaling and power consumption by a UAV WTRU performing continuous measurement reporting.

In examples, a L1 measurement reporting functionality/behavior may be dependent on a height condition, a speed condition, and/or a waypoint condition. For example, a WTRU may determine its LTM reporting behavior (e.g., one or more reporting conditions) based on a height (e.g., a relative height) of the WTRU, a speed (e.g., a relative speed) of the WTRU, and/or a location (e.g., relative location) of the WTRU. The WTRU may receive a configuration of (e.g., configuration information indicating) a first reporting behavior and a second reporting behavior (e.g., reporting periodicity, number of cells/beams included in the report). For example, the reporting condition may include a periodicity, a proximity to a certain waypoint, and/or a height of the WTRU. The first reporting behavior may be associated with the WTRU not meeting the height condition and/or the waypoint condition. The WTRU may receive a configuration for a condition associated with the height (e.g., relative height) of the WTRU, the speed (e.g., relative speed) of the WTRU, and/or a location (e.g., relative location) of the WTRU (e.g., associated with a waypoint). The WTRU may perform measurement reporting (e.g., send beam measurements to the network) according to a first configured reporting behavior when the conditions associated with the height of the WTRU, the speed of the WTRU, and/or the location of the WTRU are not met. WTRU may perform measurement reporting (e.g., send beam measurements to the network) according to the second configured reporting behavior when the conditions associated with the height of the WTRU, the speed of the WTRU, and/or the location of the WTRU are met.

The following are examples of terminology and definitions used herein. “Waypoints” in the context of UAV may refer to sets of 3-dimensional coordinates that identify a point in physical space. “Flight path” may include one or more waypoints, and may optionally include a timestamp, which may indicate the position and the time at which the WTRU may expect to be at that position. For example, each waypoint may be numbered or indexed, such that each waypoint may be uniquely identified. “Perform LTM” or “perform LTM procedures” may refer to performing one or more (e.g., any/all) of the steps described in FIG. 4. For example, “perform LTM” or “perform LTM procedures” may refer to early synchronization in DL and/or UL to one or more of the candidate cells, performing L1 measurements and reporting on one or more of the candidate cells, and/or switching (e.g., performing handover) between candidate cells. In examples, “perform LTM” may mean that the WTRU moves/switches between multiple candidate cells during the procedure.

One or more “candidate cell sets” may refer to groups of more than one RRC configuration that may correspond to a handover configuration for one or more candidate SpCells and/or SCells. In examples, this may be modelled or received as one or more complete RRC Reconfiguration messages, one or more cell group configurations, and/or one or more cell configurations. For example, each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which may be used in L1 and MAC signaling to refer to specific indexes. In examples, a MAC CE triggering the reconfiguration may include a candidate configuration index informing the WTRU which cell to perform the reconfiguration to. In examples, the one or more candidate cell groups may be configured as a single list or group of candidate cell configurations at RRC. The grouping may occur at the early sync or LTM execution phase (e.g., rather than the configuration phase). For example, the candidate cell set may be considered as a single group in terms of an RRC configuration list or group, while the cells selected for performing early sync, L1 measurements, and/or LTM execution may depend on a further grouping into multiple subsets of the overall candidate cell list. For example, the grouping itself may not be modelled at RRC using candidate configuration identifiers. For example, the grouping may be executed as part of the early sync or the LTM execution procedure. Throughout this application, an LTM candidate configuration may apply to any type of preconfigured cell information. For example, a WTRU may be configured with one or more conditional reconfigurations such as conditional handover (CHO), conditional PSCell addition (CPA) and/or conditional PSCell change (CPC) which may be valid before and/or after a cell change, or valid in certain cells.

In examples, a L1 measurement herein may include a measurement of RSRP, RSRP, RSSI, etc., which may be performed by a WTRU of a cell, beam, set of cells, and/or set of beams. In examples, such L1 measurement may be similar to L3 measurements reported in RRM, with differences in the filtering, reference signals measured, reporting mechanisms, and/or the like.

Herein, solutions are described which may trigger reporting, and/or define WTRU behavior, based on a specific waypoint (e.g., coordinates in the path of a UAV). For example, such a waypoint may be used interchangeably with location. For example, the solution may use any mechanism to define the geographical location of a WTRU in a space.

Herein, measurements may refer to L1 measurements for LTM. Certain solutions herein may apply also to RRM/L3 measurements, as well as other measurements (e.g., measurements of speed, location, height, traffic, and the like).

In examples herein, a WTRU may be configured with a height-based condition used to determine a parameter, behavior, etc. In examples, height-based conditions may be configured by the network (e.g., in RRC), or may be predefined. For example, height-based conditions may be configured by the network, and may then be enabled/disabled by NW signaling (e.g., MAC CE, DCI, SIB, RRC, etc.). For example, height-based conditions may be enabled/disabled by another condition herein (e.g., speed-based condition, waypoint-based condition, etc.).

A height-based condition may be in the form of the WTRU reaching at least or at most a certain height. For example, a height-based condition may be that a WTRU's height is above a configured threshold, a WTRU's height is below a configured threshold, and/or a WTRU's height is between two configured thresholds. A height-based condition may be in the form of a change in the WTRU's height. For example, a height-based condition may be that a WTRU's height changes by an amount greater than a threshold, possibly within a configured time period/duration; a WTRU's height increased by an amount greater than a threshold, possibly within a configured time period/duration; a WTRU's height decreases by an amount greater than a threshold, possibly within a configured time period/duration; the change of the WTRU's height has increased by an amount greater than a threshold, possibly within a configured time period/duration; and/or the change of the WTRU's height has decreased by an amount greater than a threshold, possibly within a configured time period/duration.

A height-based condition may be in the form of a time the WTRU spends at a certain height. For example, a height-based condition may be: a WTRU's height stays at the same value for at least a configured period of time; a WTRU's height stays within a configured range at least for a configured period of time; a WTRU's height changes by less than a configured amount over a configured period of time; and/or a WTRU has spent the most amount of time, within a configured period of time, at a certain height.

In examples herein, a WTRU may be configured with a waypoint-based condition used to determine a parameter, behavior, etc. Such waypoint-based condition may be configured by the network (e.g., in RRC), or may be predefined. Such waypoint-based condition may be configured by the network, and may then be enabled/disabled by NW signaling (e.g., MAC CE, DCI, SIB, RRC, etc.,). Such waypoint-based condition may be enabled/disabled by another condition herein (e.g., speed-based condition, height-based condition, etc.).

A waypoint-based condition may be in the form of the WTRU reaching a waypoint (e.g., a given coordinate) and/or being in proximity of a waypoint, possibly that was earlier reported in the WTRU's flight path. The condition may be configured for one or more specific waypoints or may be generic for any number of waypoints. For example, a condition may be that a WTRU may be located at a certain waypoint, or a WTRU is within a certain configured distance from a waypoint.

A waypoint-based condition may be in the form of a time to reach a waypoint or time spent at a waypoint. For example, a waypoint-based condition may be that: a WTRU will be within a configured distance from a waypoint in less than a configured threshold time. a WTRU spends at least a configured period of time within a configured distance from a certain waypoint, a WTRU will not be within a configured distance from a waypoint for more than a configured threshold time, and/or a WTRU spends less than a configured period of time within a configured distance from a certain waypoint.

A waypoint-based condition may be in the form of a change in a reported waypoint. For example, a waypoint-based condition may be: a waypoint changes by at least a configured distance, the timestamp associated with a waypoint changes by at least a configured time, and/or the WTRU skips a waypoint (e.g., arrives at a second waypoint that it was expected to arrive at after a first waypoint, before arriving at the first waypoint, etc.)

In examples herein, a WTRU may be configured with a speed-based condition used to determine a parameter, behavior, and the like. For example, speed-based conditions may be configured by the network (e.g., in RRC), or may be predefined. Such speed based condition may be configured by the network, and may then be enabled/disabled by NW signaling (e.g., MAC CE, DCI, SIB, RRC, and the like). Such speed-based condition may be enabled/disabled by another condition herein (e.g., height-based condition, waypoint-based condition, and the like).

A speed-based condition may be in the form of the WTRU reaching at least or at most a certain speed. For example, a speed-based condition may be: a WTRU's speed is above a configured threshold, a WTRU's speed is below a configured threshold, and/or a WTRU's speed is between two configured thresholds.

A speed-based condition may be in the form of a change in the WTRU's speed (e.g., acceleration/deceleration). For example, a speed-based condition may be: a WTRU's speed changes by an amount greater than a threshold, possibly within a time period, a WTRU's speed increased by an amount greater than a threshold, possibly within a time period; and/or a WTRU's speed decreases by an amount greater than a threshold, possibly within a timer period.

A speed-based condition may be in the form of a time the WTRU spends at a certain speed. For example, a speed-based condition may be: a WTRU's speed stays at the same value for at least a configured period of time; a WTRU's speed stays within a configured range at least for a configured period of time; and/or a WTRU's speed changes by more/less than a configured amount over a configured period of time.

Herein, an LTM measurement parameter may include any parameter or value used to generate a L1/L2 measurement. For example, an LTM measurement parameter may be: candidate target cells to be measured. For example, a WTRU may be configured with one or more lists of cells, frequencies, or RATs to be measured. These cells may or may not belong to the LTM candidate cells.

In examples, an LTM measurement parameter may include a time to trigger (TTT) associated with an event. For example, a WTRU may be configured with one or more values of the time to trigger associated with an event and either a reporting behavior or other behavior (e.g., start synchronization, change the number of candidates measured, etc.) In examples, an LTM measurement parameter may include a number of beams averaged/used to generate a cell measurement. For example, a WTRU may be configured with one or more values for the number of beams (e.g., maximum number of beams) to average to generate a cell measurement, or the number of beams to consider when selecting a beam measurement. In examples, an LTM measurement parameter may include a hysteresis for triggering a condition or cancelling a condition. For example, a WTRU may be configured with one or more values of a hysteresis used to determine when a measured value should trigger a condition. In examples, an LTM measurement parameter may include the number of samples to average to generate a measurement amount. For example, a WTRU may be configured with one or more number of samples (e.g., in time, in different resources, etc.) to be used when generating a measurement (e.g., number of samples to average). In examples, an LTM measurement parameter may include one or more coefficients used in averaging/filtering. For example, a WTRU may be configured with one or more filter coefficient sets. Specifically, a WTRU may use a first configured set of filter coefficients or a second set of filter coefficients.

In examples, an LTM measurement parameter may include a time difference between samples taken for averaging. For example, a WTRU may be configured with a different value of the time difference between samples used for performing a measurement. For example, a WTRU may be configured with whether certain specific samples are used or not when determining an averaging. In examples, an LTM measurement parameter may include a measurement offset. For example, a WTRU may be configured with a different measurement offset to apply (e.g., to a serving cell, a neighbor cell, certain frequencies, certain RATs, etc.) For example, a WTRU may be configured with a different cell whose measurement offset (e.g., configured by that cell) should be applied at a given time. Specifically, the WTRU may select one or another cell and apply the measurement offset configured by/for that cell. In examples, an LTM measurement parameter may include one or more thresholds to trigger measurement reports/indications. For example, a WTRU may be configured with different absolute/relative thresholds of signal levels to trigger measurement reports (e.g., absolute thresholds of serving cells, absolute threshold of neighbor cells, relative threshold between serving cells and neighbor cells, etc.). In examples, an LTM measurement parameter may include a CSI measurement configuration. In examples, an LTM measurement parameter may include a set of aperiodic CSI trigger states. In examples, an LTM measurement parameter may include at least one CSI reporting configuration, or at least one parameter thereof such as: periodicity and offset, resources for channel measurement (e.g. SSB or CSI-RS resource set), CSI-IM (CSI-Interference Measurement) resources for interference measurement, NZP (non-zero power) CSI-RS resources for interference measurement, and/or report quantity. In examples, an LTM measurement parameter may include a set of TCI states associated to CSI-RS resources for channel or interference measurements.

Herein, an LTM reporting functionality/behavior may include any different behavior related to how L1 measurements may be reported to the network for LTM. For example, a WTRU may determine any of the following based on a condition. In examples, in the case of reporting interval, a WTRU may be configured with different reporting intervals (e.g., time between successive reports) related to L1 measurements, and/or a WTRU may be configured with different measurement reporting prohibit timers (e.g., the minimum amount of time the WTRU needs to wait after sending a measurement report before sending the next one, etc.). In examples, in the case of format of the message used for reporting, a WTRU may use a different number of bits to represent a quantity (for example, a height, an RSRP measurement, etc.). For example, a WTRU may use different format MAC CEs to report measurements. In examples, in the case of how to determine which measurements to include, specifically, determining the number of cells/beams to report, a WTRU may be configured with a maximum/minimum number of beams/cells to be reported. In examples, in the case of how to determine which measurements to include, specifically, determining frequency of the cells/beams to report, a WTRU may be configured to report cells/beams associated with intra frequency (e.g., only intra frequency). Additionally or alternatively, a WTRU may be configured to report cells/beams associated with inter frequency (e.g., only inter frequency). Alternatively, a WTRU may be configured to report cells/beams associated with one or more configured frequencies that are determined based on a condition. A WTRU may be configured to report cells/beams associated with a certain RAT (e.g., EUTRA cells, NR cells, etc.). In examples, in the case of how to determine which measurements to include, specifically, determining acceptability criteria for reporting cells/beam measurement. For example, a WTRU may be configured with a threshold RSRP/RSRQ/RSSI, etc. above which a cell/beam may be reported. In examples, in the case of how to determine which measurements to include, specifically, determining how to select which cells/beams to report when more than the required/maximum number satisfy a criteria. For example, under one condition, a WTRU may report the N best beams, while under another condition, the WTRU may report the N beams which may be closest to the average.

In examples, L1 measurement reporting functionality/behavior may be dependent on height or waypoint condition. For example, WTRU may determine one or more parameters for reporting measurements based on satisfying a condition associated with a waypoint. In examples, a WTRU may determine a measurement reporting parameter associated with LTM measurements based on a condition associated with a waypoint. For example, a WTRU may determine the value or configuration to use for any measurement reporting parameter defined herein based on a condition associated with a waypoint.

In examples, a WTRU may be configured with a set of thresholds used to trigger measurement reports (e.g., absolute thresholds that are compared with serving or neighbor cell measurements, relative thresholds that compare serving cell with neighbor cell, etc.) that are associated with different waypoints. For example, if the WTRU approaches a waypoint (e.g., the current distance to the waypoint is below a configured threshold), the WTRU may apply the associated threshold value(s) for that waypoint when determining whether to trigger a measurement report or not.

In examples, a WTRU may be configured with a set of TTT values (e.g., for determining if the serving or neighbor cell signal levels fulfill the measurement reporting thresholds for a given time to prevent frequent measurement reports) used to trigger measurement reports that are associated with different waypoints. For example, if the WTRU approaches a waypoint (e.g., the current distance to the waypoint is below a configured threshold), the WTRU may apply the associated TTT value(s) for that waypoint when determining whether to trigger the measurement report or not. In one example, a WTRU may be configured with a set of measurement reporting periodicities (e.g., if periodic measurement reporting is configured) used to trigger measurement reports that are associated with different waypoints. For example, when the WTRU is at a first waypoint (e.g., the current distance to the waypoint is below a configured threshold), the WTRU may perform periodic measurement reporting at a periodicity associated with that waypoint, and when it is at a second waypoint, it may perform periodic measurement reporting at a second periodicity associated with the second waypoint, etc. In examples, the WTRU may be configured not to perform periodic measurement reporting at all at a certain waypoint or a set of waypoints (e.g., between some location co-ordinate ranges), but the WTRU may be configured to perform periodic measurement reporting at other waypoints.

In examples, a WTRU may be configured with a measurement reporting configuration that is enabled/activated (e.g., only enabled/activated) at certain waypoint(s). For example, the WTRU may be (e.g., always) performing the measurements, but no measurement reporting may be triggered unless the WTRU is at/near the configured waypoint(s), and/or the reporting at the waypoints where reporting is enabled can be controlled differently according to any of the examples described herein. The association of measurement reporting parameters and waypoint may be made in a way where the WTRU is configured to use one set of parameters in a set/range of waypoint, another set of parameters in another set/range of waypoints, etc. For example, a WTRU may be configured with a first range of waypoints/locations (E.g., between coordinates 1 and coordinates 2) and a second range of waypoints/locations (e.g., between coordinates 3 and coordinates 4). For the first range of waypoints, the WTRU may be configured to use a first TTT, and for the second range of waypoints, the WTRU may use a second TTT.

In examples, WTRU may determine one or more parameters for reporting measurements based on satisfying a condition associated with height. In examples, a WTRU may determine a measurement reporting parameter associated with LTM measurements based on a condition associated with height. For example, a WTRU may determine the value or configuration to use for any measurement reporting parameter defined herein based on a condition associated with a height of the WTRU.

In examples, a WTRU may be configured with a set of thresholds used to trigger measurement reports (e.g., absolute thresholds that are compared with serving or neighbor cell measurements, relative thresholds that compare serving cell with neighbor cell, etc.) that are associated with different WTRU heights. For example, if the WTRU is at a certain height, the WTRU may apply the associated threshold value(s) for that height when determining whether to trigger a measurement report or not. In examples, a WTRU may be configured with a set of TTT values (e.g., for determining if the serving or neighbor cell signal levels fulfill the measurement reporting thresholds for a given time to prevent frequent measurement reports) used to trigger measurement reports that are associated with different heights. For example, if the WTRU is at a certain height, the WTRU may apply the associated TTT value(s) for that height when determining whether to trigger the measurement report or not.

In examples, a WTRU may be configured with a set of measurement reporting periodicities (e.g., if periodic measurement reporting is configured) used to trigger measurement reports that are associated with different heights. For example, when the WTRU is at a first height, the WTRU may perform periodic measurement reporting at a periodicity associated with that height, and when it is at a second height, it may perform periodic measurement reporting at a second periodicity associated with the second height, etc. In examples, the WTRU may be configured to perform periodic measurement reporting when (e.g., only when) the WTRU is at a certain range of height (e.g., below a certain height, above a certain height, between two height levels, etc.). In examples, a WTRU may be configured with a measurement reporting configuration that is enabled/activated (e.g., only) at certain height(s). For example, the WTRU may be (e.g., always) performing the measurements, but no measurement reporting will be triggered unless the WTRU is at the configured height(s) for measurement reporting, and the reporting at the heights where reporting is enabled may be controlled differently according to any of the examples given above. In examples, the association of measurement reporting parameters and WTRU height may be made in a way where the WTRU may be configured to use one set of parameters in a set/range of heights, another set of parameters in another set/range of heights, etc. For example, a WTRU may be configured with a first range of heights (e.g., between H1 and H2) and a second range of heights (e.g., between H3 and H4). For the first range of heights, the WTRU may be configured to use a first TTT, and for the second range of heights, the WTRU may use a second TTT.

In examples, a WTRU may determine one or more parameters for reporting measurements based on satisfying a condition associated with speed. In examples, a WTRU may determine a measurement reporting parameter associated with LTM measurements based on a condition associated with the WTRU's speed. For example, a WTRU may determine the value or configuration to use for any measurement reporting parameter defined herein based on a condition associated with speed. For example, a WTRU may determine its vertical speed, and may determine its measurement reporting configuration based on the determined vertical speed. For example, the WTRU may be configured to use a first set of measurement reporting parameters (e.g., thresholds, TTT, reporting periodicities, etc.) if the vertical speed is below a threshold, and a second set of measurement reporting parameters if the vertical speed is above a threshold. For example, the WTRU may be configured to use a set of measurement reporting parameters if the WTRU's height is increasing and a second set of measurement reporting parameters if the WTRU's height is decreasing. For example, a WTRU may be configured to use a first set of measurement reporting parameters for speeds below a threshold and a second of measurement reporting parameters for a speed above a threshold.

In some examples, apart from having different values for the different parameters, some of the measurement reporting parameters may not be applicable to certain waypoints, heights or moving at a certain speed value(s). In some examples, the WTRU may be configured not to perform measurement reporting at all (e.g., measurements of certain frequencies, RATs, cells, cells with SSB at a certain periodicity, etc.) when the WTRU is at certain waypoints, heights or traveling at certain speed value(s). In some examples, the WTRU may be configured with different configurations for the number of cells and/or beams per cell to include depending on waypoint(s), height(s), or speed values. In some examples, the WTRU may be configured to switch between event-based measurement reporting and periodic based measurement reporting depending on waypoint(s), height(s) or speed value(s). In some examples, the WTRU may be configured to switch between L2 based measurement reporting (e.g., via a MAC CE) and L3 based measurement reporting (e.g., RRC measurement report) depending on waypoint(s), height(s) or speed values.

In examples, the measurement reporting parameters such as TTT, thresholds, periodicities, etc., discussed herein along with the different solutions are not exhaustive measurement reporting related parameters. In general, the configuration that is associated with different waypoints, height, speed, and the like, may include any parameter that affects how the WTRU reports measurements. For example, one or more information elements associated with measurement reporting configuration (e.g., ReportConfigNR for L3 measurement reporting, L1 measurement reporting parameters such as for CSI-RS reporting, etc.) may be dependent on waypoint, height or speed.

1. A wireless transmit/receive unit (WTRU) comprising a processor configured to:
receive configuration information from a network indicating first reporting behavior and second reporting behavior to be applied when reporting measurements associated with a beam, wherein the configuration information indicates a condition associated with one or more of a height of the WTRU, a speed of the WTRU, or a location of the WTRU;
determine whether the condition associated with one or more of the height of the WTRU, the speed of the WTRU, or the location of the WTRU has been satisfied; and
send a report indicating the beam measurements of the candidate set of cells using the first reporting behavior or the second reporting behavior based on whether the condition associated with one or more of the height of the WTRU, the speed of the WTRU, or the location of the WTRU has been satisfied.

2. The WTRU of claim 1, wherein the beam measurements of the candidate set of cells are reported using the first reporting behavior when the condition associated with one or more of the height of the WTRU, the speed of the WTRU, or the location of the WTRU has not been satisfied.

3. The WTRU of claim 1, wherein the beam measurements of the candidate set of cells are reported using the second reporting behavior when the condition associated with one or more of the height of the WTRU, the speed of the WTRU, or the location of the WTRU has been satisfied.

4. The WTRU of claim 1, wherein the first reporting behavior comprises a first reporting periodicity or a first number of beams included in the report.

5. The WTRU of claim 1, wherein the second reporting behavior comprises a second reporting periodicity or a second number of beams included in the report.

6. The WTRU of claim 1, wherein the processor is further configured to determine a reporting interval to send the measurements based on the condition.

7. The WTRU of claim 6, wherein the reporting interval is associated with event-based reporting or periodic reporting.

8. The WTRU of claim 1, wherein the location of the WTRU comprises a relative location associated with a waypoint.

9. The WTRU of claim 1, wherein the height of the WTRU comprises a relative height of the WTRU.

10. The WTRU of claim 1, wherein the speed of the WTRU comprises a relative speed of the WTRU.

11. A method performed by a wireless transmit/receive unit (WTRU), the method comprising:
receiving configuration information from a network indicating first reporting behavior and second reporting behavior to be applied when reporting measurements associated with a beam, wherein the configuration information indicates a condition associated with one or more of a height of the WTRU, a speed of the WTRU, or a location of the WTRU;
determining whether the condition associated with one or more of the height of the WTRU, the speed of the WTRU, or the location of the WTRU has been satisfied; and
sending a report that indicates the beam measurements of the candidate set of cells using the first reporting behavior or the second reporting behavior based on whether the condition associated with one or more of the height of the WTRU, the speed of the WTRU, or the location of the WTRU has been satisfied.

12. The method of claim 11, wherein the beam measurements of the candidate set of cells are reported using the first reporting behavior when the condition associated with one or more of the height of the WTRU, the speed of the WTRU, or the location of the WTRU has not been satisfied.

13. The method of claim 11, wherein the beam measurements of the candidate set of cells are reported using the second reporting behavior when the condition associated with one or more of the height of the WTRU, the speed of the WTRU, or the location of the WTRU has been satisfied.

14. The method of claim 11, wherein the first reporting behavior comprises a first reporting periodicity or a first number of beams included in the report.

15. The method of claim 11, wherein the second reporting behavior comprises a second reporting periodicity or a second number of beams included in the report.

16. The method of claim 11, further comprising determining a reporting interval to send the measurements based on the condition.

17. The method of claim 16, wherein the reporting interval is associated with event-based reporting or periodic reporting.

18. The method of claim 11, wherein the location of the WTRU comprises a relative location associated with a waypoint.

19. The method of claim 11, wherein the height of the WTRU comprises a relative height of the WTRU.

20. The method of claim 11, wherein the speed of the WTRU comprises a relative speed of the WTRU.
